(19) United States
(12) Patent Application Publication
(10) Pub. No.: US 2012/0052245 A1
(43) Pub. Date: Mar. 1, 2012

(54) METHOD AND APPARATUS FOR CROSS-WEB COEXTRUSION AND FILM THEREFROM

(76) Inventors: Travis B. Hoium, Minneapolis, MN (US); Brent R. Hansen, New Richmond, WI (US); Matthew J. Bibeau, Oakdale, MN (US); David F. Slama, City of Grant, MN (US)

(21) Appl. No.: 13/203,584

(22) PCT Filed: Feb. 24, 2010
(86) PCT No.: PCT/US2010/025151

§ 371 Date: Nov. 7, 2011

Related U.S. Application Data
(60) Provisional application No. 61/156,020, filed on Feb. 27, 2009.

(51) Int. Cl. B32B 3/30; B29C 47/04

(52) U.S. Cl. 428/156; 264/173.16; 425/114

(57) ABSTRACT

A method and apparatus for making a segmented multicomponent polymeric film. The method includes providing at least two separated melt streams, including at least two different polymeric compositions, that are separated in a first separation dimension; dividing in a second separation dimension substantially orthogonal to the first separation dimension at least some of the separated melt streams into at least two segmented flow streams; redirecting at least some of the segmented flow streams, with at least some of the segmented flow streams being sequentially redirected in both separation dimensions; and converging the segmented flow streams into a segmented multicomponent polymeric film. A segmented multicomponent polymeric film having projections is also presented, the film having a top surface and a bottom surface, each surface having a different arrangement of polymeric segments that at least partially alternate along the film's cross direction and extend continuously in the film's length direction.

### BACKGROUND

Various patents describe methods for side-by-side coextrusion of different thermoplastic materials. Generally, certain dies or die inserts are used to direct separate melt streams into an alternating pattern. Those methods provide films that have side-by-side zones of the thermoplastic materials. Methods for coextrusion of different thermoplastic materials to provide multilayer polymeric films are also known. For example, certain feedblocks or other extrusion apparatuses can be used to separate and reposition melt streams into multilayer constructions.

### SUMMARY

Disclosed herein are a method and apparatus for making a segmented multicomponent polymeric film and the film made therefrom. The method comprises introducing at least two separated melt streams that are separated in a first separation dimension (e.g., cross web or thickness dimension) to a first manipulation stage of an extrusion element having at least first and second manipulation stages. The at least two separated melt streams comprise at least two different polymeric compositions. At least some of the separated melt streams are divided in a second separation dimension into at least two segmented flow streams, wherein the second separation dimension is substantially orthogonal to the first separation dimension. Then at least some of these segmented flow streams are redirected. Each redirected segmented flow stream is independently redirected in the first separation dimension or in the second separation dimension, but at least some of the segmented flow streams are sequentially redirected in both separation dimensions in the first and second manipulation stages, respectively. Such redirecting can be repeated multiple times as needed to rearrange the segmented flow streams as desired in both the separation dimensions. The redirected segmented flow streams are then converged with any other segmented flow streams (i.e., those that were not redirected) and any separated melt streams (i.e., those that were not divided into segmented flow streams) to form a segmented multicomponent polymeric film having a upper surface and a lower surface, each surface having a different arrangement of the at least two different polymeric compositions in segments that at least partially alternate along the film's cross direction and extend continuously in the film's length direction. In some embodiments, the at least two separated melt streams are arranged so as to at least partially alternate at least the two different polymeric compositions in the first separation dimension.

The coextrusion apparatus disclosed herein comprises an extrusion element, which comprises a first manipulation stage, a second manipulation stage, and a converging stage. The first manipulation stage comprises first flow channels for independently redirecting segmented flow streams in a first separation dimension or a second separation dimension, wherein the first separation dimension is substantially orthogonal to the second separation dimension. The segmented flow streams arise from at least two separated melt streams that are separated (i.e., physically separated) in the first separation dimension, with at least some of the separated melt streams further divided in the second separation dimension each into at least two of the segmented flow streams. The second manipulation stage comprises second flow channels for redirecting at least some of the segmented flow streams in the first separation dimension or the second separation dimension such that at least some of the segmented flow streams are sequentially redirected in both separation dimensions in the first and second manipulation stages, respectively. The converging stage comprises third flow channels for converging the segmented flow streams, including the redirected segmented flow streams, and any separated melt streams (i.e., those that were not divided into segmented flow streams) to form a segmented multicomponent polymeric film. The third flow channels are in fluid communication with the second flow channels, and the second flow channels are in fluid communication with the first flow channels.

In the method and apparatus described above, the various manipulation stages within the extrusion element may be formed, for example, by multiple discrete sub-elements (e.g., two or more elements or multiple sections of a single element). The extrusion element can be formed such that each manipulation stage is formed using a separate sub-element that can be combined with other matching sub-elements in as many manipulation stages as desired. In some embodiments, the extrusion element comprising various manipulation stages (e.g., first and second manipulation stages) is formed by at least one die insert. The extrusion element can also be formed integrally with a die and/or feedblock.

In some embodiments, the coextrusion apparatus further comprises a feedblock comprising fourth flow channels for separating at least two feedstock melt streams each into at least two of the separated melt streams and arranging the separated melt streams so as to at least partially alternate the at least two feedstock melt streams in the first separation dimension, wherein the fourth flow channels are in fluid communication with the first flow channels.

The method and apparatus described herein allows the formation of the segmented multicomponent polymeric films without the need for ultrasonic welding, adhesives, or other methods of bonding two dissimilar webs together. These types of production steps could therefore be eliminated.

The segmented multicomponent film disclosed herein has a top surface and a bottom surface, and each surface has a different arrangement of polymeric segments that at least partially alternate along the film's cross direction and extend continuously in the film's length direction (i.e., the arrangement of polymeric segments along the top surface is different from the arrangement along the bottom surface of the film). At least a portion of the polymeric segments in the film can be provided with projections (e.g., hooks). The films described herein can have selected properties in any desired location along the cross-direction or the thickness direction of the film, providing, for example, hook strips with great versatility and the ability to be tailored for a variety of applications.

In this application:

Terms such as “a”, “an”, and “the” are not intended to refer to only a singular entity, but include the general class of which a specific example may be used for illustration. The terms “a”, “an”, and “the” are used interchangeably with the term “at least one”.

The term “extrusion element” is used to identify any structure providing flow channels or other means of dividing and directing flow streams and other features as described, regardless if in a die, feedblock, insert(s), or another component.

The term “multicomponent” refers to having two or more different polymeric compositions.

### BRIEF DESCRIPTION OF THE DRAWINGS

The disclosure may be more completely understood in consideration of the following detailed description of various embodiments of the disclosure in connection with the accompanying drawings.

FIG. 1 is a schematic view of an extrusion apparatus useful for some embodiments of the method disclosed herein.

FIG. 2 is a schematic view of an extrusion element described herein connected to a feedblock, which components are useful in the extrusion apparatus of FIG. 1.

FIG. 3 is a perspective view of the flow channels in the feedblock and manipulation stages for one embodiment of the method or apparatus disclosed herein.

FIG. 4 is a further perspective view of the flow channels for the first and second manipulation stages and subsequent converging for one embodiment of the method or apparatus disclosed herein.

FIG. 5 is a further perspective view of the flow channels shown in FIGS. 3 and 4, which shows the position of the segmented flow streams after redirecting in the first manipulation stage and shows how the segmented flow streams are redirected in the second manipulation stage for one embodiment of the method or apparatus disclosed herein.

FIG. 6 is a further perspective view of the flow channels shown in FIGS. 3, 4, and 5, which shows the position of the segmented flow streams after redirecting in the second manipulation stage and shows how the segmented flow streams and melt streams are converged in one embodiment of the method or apparatus disclosed herein.

FIG. 7 is a perspective view of the flow channels in a die leading to an extrusion element at a die lip according to another embodiment of the method or apparatus disclosed herein.

FIG. 8 is a side view of the extrusion element farther back in the die according to another embodiment of the method or apparatus disclosed herein.

FIG. 9 is a cross-sectional view of an embodiment of a segmented multicomponent polymeric film.

FIG. 10 is a perspective view of an embodiment of a segmented multicomponent polymeric film where one of the segments is provided with hooks.

FIG. 10a is a cross-sectional view of an exemplary projection formed on a segment of a segmented multicomponent polymeric film, where the segment has two different materials in the thickness direction.

FIG. 11 is a schematic view of an apparatus and method for making some embodiments of the segmented multicomponent polymeric film, where at least one of the segments is provided with projections.

FIG. 12 is a cross-sectional view of the die lip used for Examples 4 and 5.

### DETAILED DESCRIPTION

The method of making a segmented multicomponent polymeric film disclosed herein includes extruding multiple separate polymeric melt streams through extrusion element 2, shown, for example, in FIG. 2. Separated generally refers to having a space between the melt streams, for example, the separated melt streams may each be in discrete flow channels. Generally, in the embodiment illustrated in FIGS. 2-5, feedstock melt streams are separated and redirected within feedblock 3 and extrusion element 2 into separated melt streams and multiple segmented flow streams formed from each polymeric composition. Some of these segmented flow streams 10″, 11″, and 12″ are redirected in the x and z dimensions in multiple manipulation stages. In some embodiments, redirecting refers to causing adjacent segmented flow streams (e.g., segmented flow streams arising from the same separated melt stream) to diverge. The redirected segmented flow streams 10″, 11″ and 12″ are eventually converged into a segmented multicomponent polymeric film where the segments can be arranged in any desired pattern along the cross direction and the thickness direction of the segmented multicomponent polymeric film.

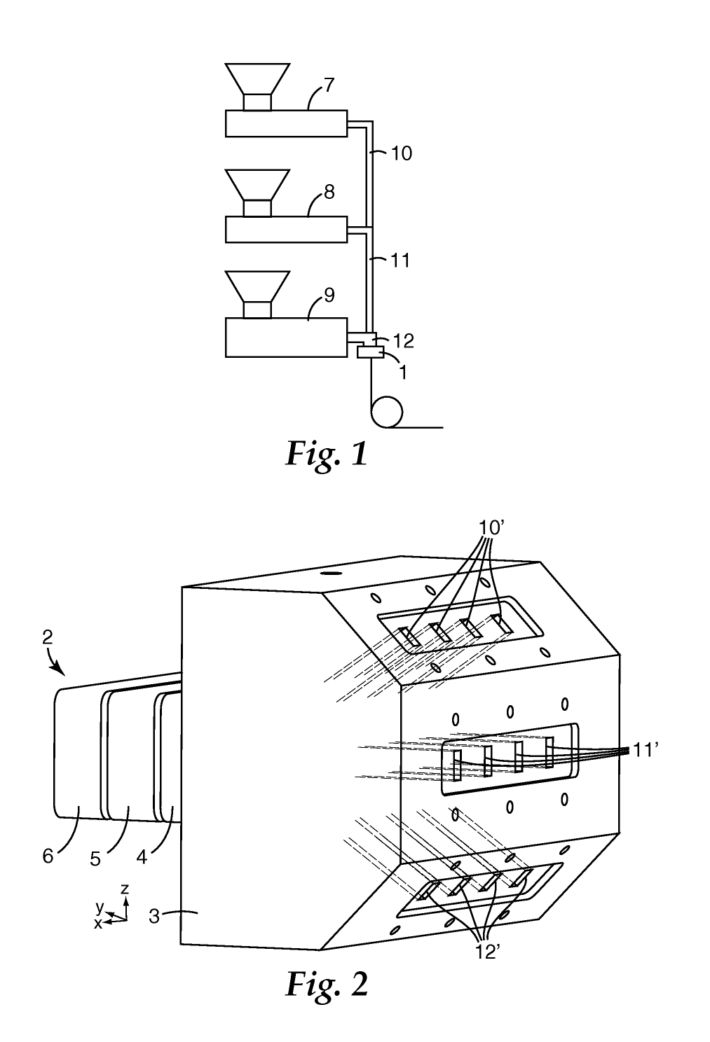

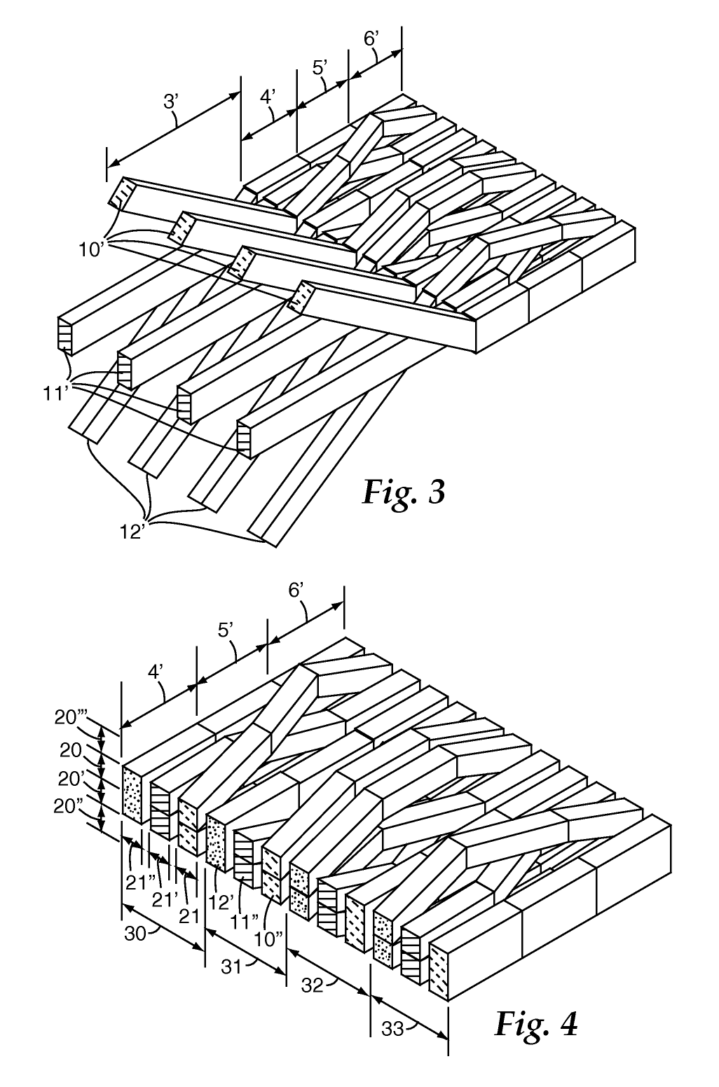

An extrusion apparatus schematically illustrated in FIG. 1 can be used in the method of making the segmented multicomponent polymeric film disclosed herein. As shown in FIGS. 1 and 2, feedstock melt streams 10, 11, and 12 are delivered from conventional extruders 7, 8, and 9 through the die 1 having at least one extrusion element 2. Three feedstock melt streams 10, 11, and 12 shown in FIG. 1 are kept separate before they are introduced to feedblock 3. In this exemplary embodiment, feedblock 3 is connected with extrusion element 2, which comprises three die inserts or three sections of a die insert 4, 5, and 6. Die inserts (or die insert sections) 4, 5, and 6 correspond to manipulation stages 4′, 5′, and 6′, shown in FIGS. 3-6. Each of the die inserts 4, 5, 6 comprises multiple zones in both the x and z directions (i.e., along both its x- and z-axes). The x-axis of the die insert 4, 5, or 6 generally corresponds to the cross direction of the segmented multicomponent polymeric film that is formed, and the z-axis of die insert 4, 5, or 6 generally corresponds to the thickness direction of the segmented multicomponent polymeric film. The y-axis shown in FIG. 2 generally corresponds to the machine or length direction of the segmented multicomponent polymeric film.

Each element (e.g., insert) for a given manipulation stage will generally have flow channels that extend from an inlet face to an outlet face in a straight line. These flow channels could taper or expand but if so would typically do so in a continuous manner, without changes in the flow direction. The flow channels could also be of any given size or shape as desired. In some embodiments, the flow channels have a rectangular (e.g., square) cross-section. The flow channels are also typically of constant cross section but can diverge or converge in their cross section within any given manipulation stage or stages if desired. This could be done to increase or decrease polymer flow to a particular segment of the final multicomponent polymeric flow stream.

A zone 20 or 21 of a die insert is defined as a region of the die insert 4, 5, or 6, corresponding to a manipulation stage 4′, 5′, or 6′, that has a segmented flow stream or separated melt stream, or is capable of having a segmented flow stream or separated melt stream. Directly adjacent zones are zones that do not have a zone between them having a segmented flow stream or separated melt stream or capable of having a segmented flow stream or separated melt stream. The zones are generally defined by the openings at the inlet faces and/or outlet faces of the die insert (i.e., the inlet or outlet openings of the flow channels). In some embodiments, directly adjacent zones will have approximately the same cross-sectional area.

In some embodiments of the method disclosed herein, providing at least two separated melt streams comprises dividing in a feedblock at least two feedstock melt streams each into at least two separated melt streams in the first separation dimension before introducing the separated melt streams to the first manipulation stage (i.e., at least four separated melt streams are provided). The at least two feedstock melt streams comprise at least two different polymeric compositions. In some embodiments, at least 3, 4, 6, 8, 10, 12, 14, 16, 18, or 20 separated melt streams are provided. In the illustrated embodiment, feedstock melt streams 10, 11, and 12 are divided in into separated melt streams 10′, 11′, and 12′ (e.g., four as shown for each of the three different compositions to provide 12 separated melt streams) in a first separation dimension, in this case along the x-axis. The separated melt streams 10′, 11′, and 12′ are each then directed in stage 3′ to zones of die insert 4 (corresponding to first manipulation stage 4′) in an alternating relationship, as shown in FIGS. 3 and 4, again in the first separation dimension (e.g., along the x-axis). The separated melt streams 10′, 11′, and 12′ are each directed to directly adjacent zones 21, 21′, 21″ of die insert 4 using the flow channels shown in stage 3′. In the illustrated embodiment, the separated melt streams each have a thickness in the z dimension corresponding to the full thickness of formed segmented multicomponent film.

In first manipulation stage 4′ at least some of the separated melt streams 10′, 11′, and 12′, are divided into a series of segmented flow streams 10″, 11″, and 12″ in a second separation dimension, which in the illustrated embodiment is along the z-axis. Dividing generally refers to putting space between portions of the melt streams, for example, portions of separated melt streams may each be put into discrete flow channels. Not all melt streams 10′, 11′, and 12′ need to be divided into segmented flow streams 10″, 11″, and 12″. For example, in first set 30, flow streams 10′ and 11′ are divided into segmented flow streams 10″ and 11″, and melt stream 12′ is not divided. These segmented flow streams 10″, 11″, and 12″ are generally formed upon entering the first manipulation stage 4′ in directly adjacent zones 20, 20′ along the z-axis of the die insert 4. Although in the illustrated embodiment, two segmented flow streams 10″, 11″, and 12″ are provided, the discrete polymeric melt streams could be divided into more segmented flow streams (e.g., 3, 4, 5, or more segmented flow streams). In some embodiments (e.g., in the illustrated embodiment), the first manipulation stage 4′ comprises a first die insert 4 having multiple zones along its x-axis for receiving the at least two separated melt streams, with at least some of the multiple zones along the x-axis having directly adjacent zones along the z-axis of the die insert for receiving the at least two segmented flow streams into the first flow channels. In the illustrated embodiment, the segmented flow streams each have a thickness in the z dimension that is less than the thickness of the separated melt stream from which it is divided.

In some embodiments of the method disclosed herein, dividing the separated melt streams and redirecting the resulting segmented flow streams are both carried out in the first manipulation stage. For example, the flow channels in first manipulation stage 4′, as shown, both divide the separated melt streams 10′, 11′, and 12′ into a series of segmented flow streams 10″, 11″, and 12″ in the second separation dimension and redirect the segmented flow streams 10″, 11″, and 12″ into directly adjacent zones of the die insert in the second separation dimension, which in the illustrated embodiment is along the z-axis. The dividing and redirecting could be done in separate manipulation stages as well. For example, separated melt streams 10′, 11′, and 12′ may be divided into a series of segmented flow streams 10″, 11″, and 12″ before entering first manipulation stage 4′ and can flow for some distance in the zones where they are formed before being redirected into directly adjacent zones of the die insert 4.

Additionally, while in the illustrated embodiment, the segmented flow streams 10″, 11″, and 12″ are formed in two separate stages, (1) the stage dividing each feedstock melt stream into multiple separated melt streams 10′, 11′, and 12′ and then interleaving the separated melt streams in an alternating fashion and (2) the first manipulation stage then dividing these alternating separated melt streams into multiple segmented flow streams, it is possible to form the multiple segmented flow streams in a single stage.

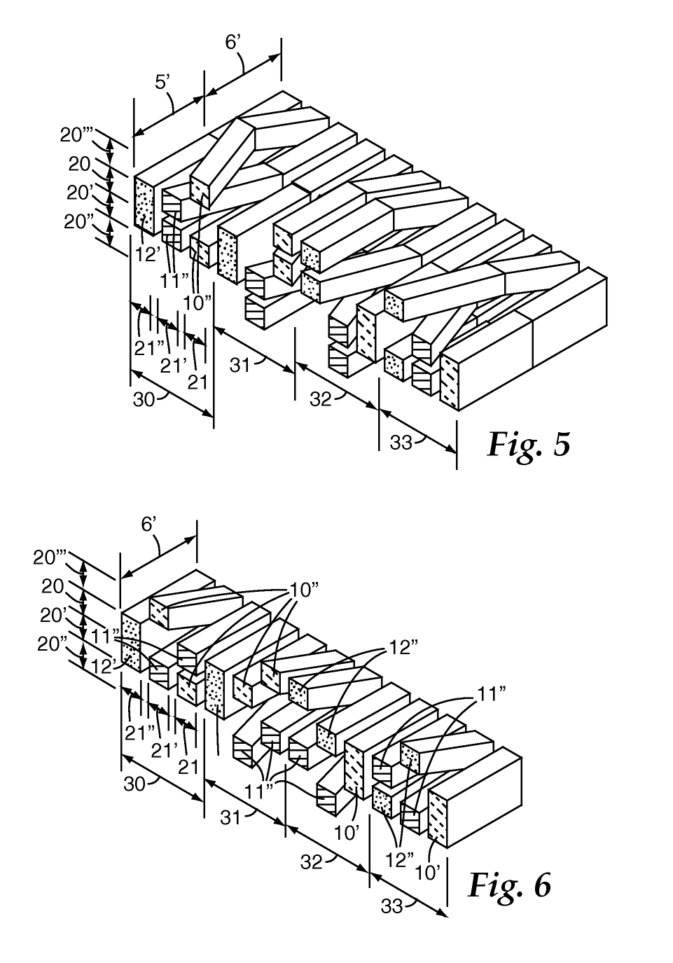

FIG. 4 illustrates the flow path of segmented flow streams 10″, 11″, and 12″ in first manipulation stage 4′ while FIG. 5 more clearly shows the zones occupied by the segmented flow streams at the end of first manipulation stage 4′ and the beginning of second manipulation stage 5′ in the illustrated embodiment. In a first set 30 (which contains segmented flow streams 10″ and 11″ and separated melt stream 12′), the top segmented flow stream 10″ is redirected upward from zone 20 into zone 20′″. In a second set 31 (which contains segmented flow streams 10″ and 11″ and separated melt stream 12′), both of the segmented flow streams 11″ are redirected downward into directly adjacent zones 20′ and 20″ of the die insert, and both of the segmented flow streams 10″ are redirected upward into directly adjacent zones 20 and 20′″ of the die insert. In a third set 32 (which contains segmented flow streams 11″ and 12″ and separated melt stream 10′), both of the segmented flow streams 12″ are redirected upward into directly adjacent zones 20 and 20′″ of the die insert, and both of the segmented flow streams 11″ are redirected downward into directly adjacent zones 20′ and 20″ of the die insert. In a fourth set 33 (which contains segmented flow streams 11″ and 12″ and separated melt stream 10′) only the top segmented flow stream 12″ is redirected upward from zone 20 into zone 20′″. In all these cases the segmented flow streams are redirected into directly adjacent zones of the die insert.

The redirection of segmented flow streams, whether in the first manipulation stage or in subsequent manipulation stages, is typically carried out such that the segmented flow streams generally avoid crossing each other in any given manipulation stage. Crossing over the flow path of a different segmented flow stream means that a segmented flow stream is redirected from a zone on one side of a different segmented flow stream into a zone on the opposite side of that different segmented flow stream. A few segmented flow streams can cross an adjacent flow stream in a single manipulation stage as long as most do not. If segmented flow streams cross in a manipulation stage then typically at least three adjacent zones of the die are used in that manipulation stage to redirect one segmented flow stream, which means at least part of one of these adjacent zones will be unusable in that manipulation stage, possibly preventing the manipulation of the segmented flow streams in this zone in that manipulation stage of the process. By keeping the flow streams from crossing, at least one segmented flow stream in each adjacent die zone can be redirected in each manipulation stage of the process. It is also possible that redirecting at least some of the segmented flow streams can be carried out within the same zone (i.e., without redirecting into a directly adjacent zone). For example, the flow channels can diverge somewhat in either dimension without placing a segmented flow stream into a directly adjacent zone.

FIG. 5 illustrates where the segmented flow streams 10″, 11″, and 12″, upon entering second manipulation stage 5′, have been redirected into directly adjacent zones 20, 20′, 20″, and 20′″ along the z-axis by the die insert of the first manipulation stage 4′ in the illustrated embodiment. FIG. 5 also shows the flow path of segmented flow streams 10″, 11″, and 12″ in second manipulation stage 5′. In the first set 30 (which contains segmented flow streams 10″ and 11″ and separated melt stream 12′), the upper segmented flow stream 10″ is redirected from zone 21 into directly adjacent zone 21′ and the upper segmented flow stream 11″ is redirected from zone 21′ into directly adjacent zone 21. In the second set 31 (which contains segmented flow streams 10″ and 11″ and separated melt stream 12′), lower segmented flow stream 10″ is moved from zone 21 into directly adjacent zone 21′, and upper segmented flow stream 11″ is moved from zone 21′ into directly adjacent zone 21. In the third set 32 (which contains segmented flow streams 11″ and 12″ and separated melt stream 10′), the lower segmented flow stream 12″ is redirected from zone 21″ to directly adjacent zone 21′, and the upper segmented flow stream 11″ is redirected from zone 21′ into directly adjacent zone 21″. In the fourth set 33 (which contains segmented flow streams 11″ and 12″ and separated melt stream 10′), the upper segmented flow stream 12″ is redirected from zone 21″ to directly adjacent zone 21′, and the upper segmented flow stream 11″ is redirected from zone 21′ into directly adjacent zone 21″. In all these cases the segmented flow streams are redirected into directly adjacent zones of the die insert.

In some embodiments, including the embodiment illustrated in FIGS. 3-6, the segmented flow streams are all redirected in the same first or second separation dimension for any given manipulation stage. In the embodiment described above, in the first manipulation stage 4′, each of the redirected flow streams is redirected in the second separation dimension (e.g., along the z-axis), and subsequently in the second manipulation stage 5′ each of the redirected flow streams is redirected in the first separation dimension (e.g., along the x-axis).

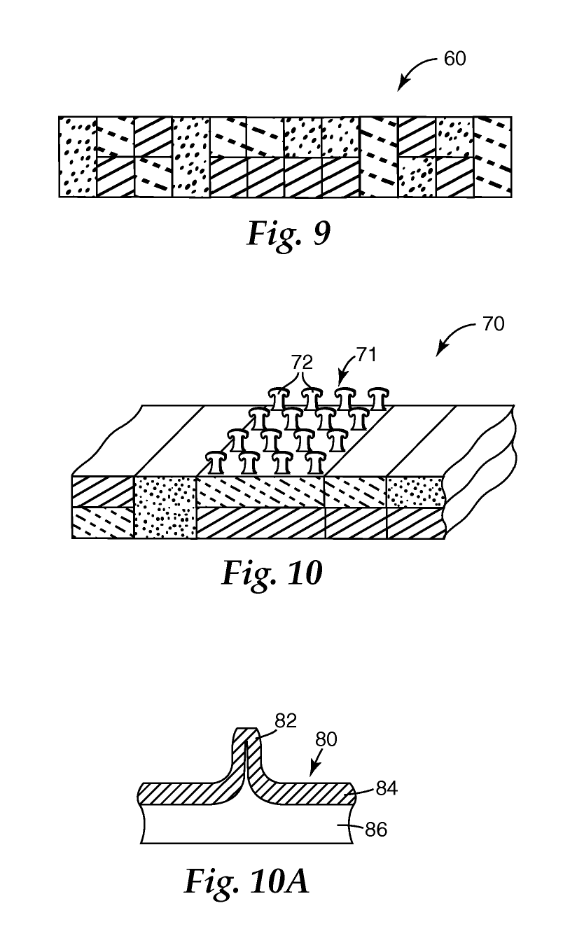

FIG. 6 illustrates where incoming segmented flow streams 10″, 11″ and 12″, upon entering third manipulation stage 6′, have been redirected into adjacent zones 21, 21′, 21″ and 21′″ along the x-axis of the die insert of the second manipulation stage 5′. In third manipulation stage 6′, in the illustrated embodiment, the segmented flow streams 10″, 11″, and 12″ are redirected along the z-axis to at least partially converge. That is, segmented flow streams 10″ and 12″ that are located in zone 20′″ at the beginning of manipulation stage 6′ are redirected into zone 20, and segmented flow streams 11″ that are located in zone 20″ at the beginning of manipulation stage 6′ are redirected to zone 20′. At the exit of the third manipulation stage 6′, the segmented flow streams 10″, 11″, and 12″ are converged into a multicomponent polymeric flow stream having a cross-section 60 as shown in FIG. 9.

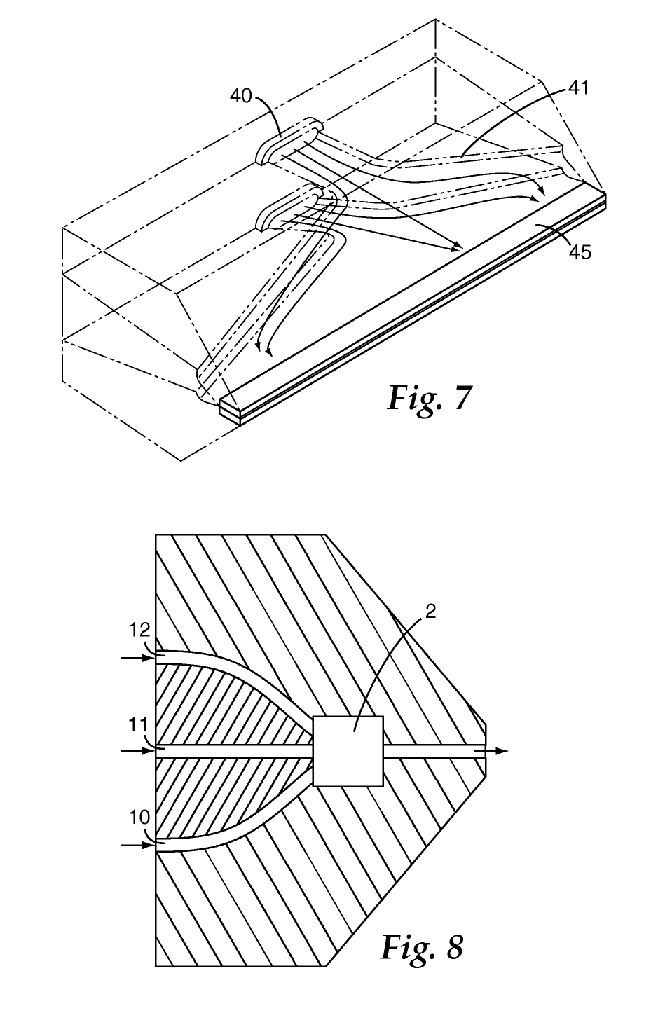

In some embodiments, a multicomponent polymeric flow stream having cross-section 60 can be formed, for example, by manipulation stages 4′, 5′, and 6′ that are located at die lip 45 as shown in FIG. 7. If formed at the die lip, the multicomponent polymeric flow stream would have a width in the cross-direction that is commensurate with the cross-direction of the resulting multicomponent polymeric film. The resolution of the polymeric segments may be maintained in this case since there is typically little or no spreading or contraction of the polymer flow before the formation of the multicomponent polymeric film.

In some embodiments, the manipulation stages 4′, 5′, and 6′, for example, are located further back in the die 1 as shown in FIG. 8. In FIG. 8, extrusion element 2 is placed at location 40 in FIG. 7. In this case the multicomponent polymeric flow stream may be spread in a coat hanger section 41 of the die 1, which may result in loss of resolution of the combined segmented flow streams as it widens in this section. This loss of resolution is generally a variation in the width of the polymer segments from the middle of the die to edge of the die. The interfaces of the polymer segments can also change from the middle to the edge of the die.

In embodiments where extrusion element 2 comprises at least one die insert, the insert or inserts can be easily fitted into a conventional die (such as a coat hanger die) as shown in FIGS. 7 and 8. Generally an insert can be readily replaced and cleaned if the die insert is formed of multiple disassembleable components, such as elements 3-6 as shown in FIG. 2. These die insert elements can be easily taken apart and cleaned for maintenance and then reassembled or recombined in new ways to form different flowpaths. Using multiple die elements to form a die insert also allows for more complex flow channels to be formed in the final die insert while using conventional methods, such as electron discharge wire machining, for forming the channels in each separate die element.

While the embodiment illustrated in FIGS. 4, 5, and 6 has three manipulation stages 4′, 5′, and 6′ redirecting the segmented flow streams 10″, 11″, and 12″ along the z-axis, x-axis, and z-axis respectively, additional elements (e.g., inserts) could be used to redirect the segmented flow streams as many times as desired. For example, 4, 5, 6, 7, 8, 9, or 10 or more manipulation stages may be used. In some embodiments, there are at least two manipulation stages that redirect the segmented flow streams in the second separation dimension. In some embodiments, there are at least two manipulation stages that redirect the segmented flow streams in the first separation dimension. The segmented flow streams after these multiple manipulation stages are then converged into a multicomponent polymeric flow stream. Although a four-component structure is shown in FIG. 2, larger multiple-element die inserts are also possible allowing for more complex flow channels or flowpaths to be formed in the assembled die insert. The die insert could also be formed in whole or in part with other parts of the die. The flow channels within the die insert however are typically substantially continuous for any given manipulation stage.

Separated melt streams not further divided into segmented flow streams during the first manipulation stage could also be redirected in any given manipulation stage, or divided into segmented flow streams in a later manipulation stage (i.e., after the first manipulation stage in the illustrated embodiment).

An extrusion element described herein is typically heated to facilitate polymer flow and layer adhesion. The temperature of the extrusion element, along with the die and optionally feedblock if separate from the extrusion element, depends upon the polymers employed and the subsequent treatment steps, if any. Generally, the temperature of the extrusion element is in the range of 350° F. to 550° F. (177° C. to 288° C.) for the polymers described hereinbelow.

Conventional coextrusion methods can be used in conjunction with the method described herein. For example, U.S. Pat. No. 4,435,141 (Weisner et al.) describes a die with die bars for making a multicomponent film having alternating segments in the film cross-direction. A die bar, or bars, at the exit region of the die segments two polymer flows using channels formed on the two outer faces of the die bar. The two sets of segmented polymer flows within these channels converge at a tip of the die bar where the two die bar faces meet. The segmented polymer flows are arranged so that when the two segmented polymer flows converge at the bar tip they form films that have alternating side-by-side zones of polymers. The use of two side-by-side die bars is also contemplated where two faces of adjacent die bars are joined and form a cavity that directs a third set of segmented polymer flows to the tip where the two die bars meet. The three segmented polymer flows converge and form an ABCABC side-by-side-by-side polymer flow. The die bars are limited to segmenting a single polymer flow into a series of laterally segmented flows along any given face of a die bar. U.S. Pat. No. 6,669,887 (Hilston et al.) uses a similar process but also teaches coextruding a continuous outer skin layer on one or both outer faces of the side-by-side coextruded film.

In another example, U.S. Pat. No. 5,429,856 (Krueger et al.) describes a process where a polymer melt stream is segmented into multiple substreams and then extruded into the center of another melt stream, which is then formed into a film. This coextrusion method creates a film that has multiple segmented flows within a matrix of another polymer.

The coextrusion methods described in U.S. Pat. Nos. 4,435,141 (Weisner et al.) or 5,429,856 (Krueger et al.), the disclosures of which are incorporated herein by reference in their entirety, can be used to provide the at least two separated melt streams that are separated in a first separation dimension, wherein the at least two separated melt streams comprise at least two different polymeric compositions, which separated melt streams are introduced to a first manipulation stage of an extrusion element disclosed herein. For example, a film having alternating segments along its cross-direction or having segmented flows within the film matrix, can be introduced to die insert 4 where the film can be separated into the at least two separated melt streams, which can then be divided and redirected.

The separated melt streams can be single or multilayer melt streams. In some embodiments, at least one of the separated melt streams comprises at least two layers of polymer, which layers define a substantially planar interface substantially orthogonal to the first separation dimension. Known multilayer extrusion processes use certain feedblocks or combining adapters, such as that disclosed in U.S. Pat. No. 4,152,387 (Cloeren). Streams of thermoplastic materials flowing out of extruders at different viscosities are separately introduced into an adapter, which contains back pressure cavities and flow restriction channels. The several layers exiting the flow restriction channels converge into a multilayer melt laminate. Other multilayer extrusion processes are disclosed in U.S. Pat. Nos. 5,501,679 (Krueger et al.) and 5,344,691 (Hanschen et al.), the disclosures of which are incorporated herein by reference, which disclosures teach various types of multilayer elastomeric laminates, with at least one elastomeric layer and either one or two relatively inelastic layers. A multilayer film, however, used in conjunction with the method disclosed herein could also be formed of two or more elastomeric layers or two or more inelastic layers, or any combination thereof, utilizing these known multilayer coextrusion techniques.

Repositioning flow streams has been described in U.S. Pat. Nos. 5,094,788 (Schrenk et al.) and 5,094,793 (Schrenk et al.). These patents describe methods of forming a multilayer polymeric film by segmenting a two layer film into a series (n) of side-by-side segments in the cross direction that are then recombined to be stacked in the thickness direction. This creates a recombined flow stream with 2n layers in the thickness direction. The recombined flow stream is then reformed into a film extending in the cross direction by a flow diverter that contracts the combined flow stream in the thickness direction while expanding the flow stream in the cross direction. Or the segmented flows arranged in the thickness direction can be expanded in the cross direction and contracted in the thickness direction before they are recombined. These steps can be repeated and can result in a film with a great number of layers. However, these methods are not used to make films with alternating segments in the cross-direction of a film.

The coextruded segmented multicomponent polymeric film disclosed herein has multiple polymeric segments arranged in the x (cross direction) and z (thickness direction) planes each extending continuously along the length of the film (the y direction or machine direction). The multiple polymeric segments comprise at least two different polymer compositions. The phrase “coextruded segmented multicomponent polymeric film” as used herein can also refer to multicomponent film layer in a multilayer film. The polymeric segments will have a different arrangement of alternating polymeric segments on the upper and lower faces of the film or film layer (e.g., when coextruded with another film layer). When the polymeric segments have a different arrangement on the upper and lower faces it means that they alternate in different areas along the extension of the film in the cross direction such that the upper face is not a mirror image of the lower face. In other words, on the upper (first) face the at least two different polymeric compositions are arranged in segments in a first at least partially alternating pattern along the extension in the cross direction, and on the lower (second) face the at least two different polymeric compositions are arranged in segments in a second at least partially alternating pattern along the extension in the cross direction, wherein the first pattern is different from the second pattern.

FIG. 9 shows cross-section 60 of a multicomponent polymeric film according to the present disclosure and/or formed according to methods disclosed herein. In the segmented multicomponent films described herein, not all the polymeric segments extend from one film surface to the opposite film surface, but rather some segments form an interface with a different polymeric segment between the two film surfaces. Although a given polymeric segment may extend to both upper and lower surfaces of the multicomponent polymeric film, not all or even a majority of polymeric segments would do this (typically less than half, or less than 20 percent, or less than 5 percent). The alternating arrangement of the polymer segments on the film surfaces is a result of generally keeping the polymers separate as they are positioned into their final designated locations in the coextruded segmented multicomponent polymeric films. Also typically an individual first polymeric segment will not film over (i.e., skin over) another second polymeric segment on a face of the film or film layer and connect to a third polymeric segment on the opposite side of the second polymeric segment.

The alternating segments for any given type of coextruded segmented polymeric film could have a wide range of possible widths. The width is generally determined by the fabricating machinery width limitations. This allows fabrication of segmented multicomponent polymeric films for a wide variety of potential uses.

A polymer segment exposed on only one surface of a segmented multicomponent polymeric film or film layer is also generally adjacent at least three other polymer segments, two on either side in the cross direction and one in the thickness direction. Each of these polymer segments could be made from same or different polymeric compositions but would be formed from different segmented flow streams and because of this may have an interface.

In some embodiments, the interfaces between polymeric segments in the segmented multicomponent polymeric film or film layer generally extend in the cross direction and thickness direction and not at angles to the cross direction and thickness direction. So for a given polymeric segment on only one face of a segmented multicomponent polymeric film or film layer the adjacent two polymeric segments on either side in the cross direction would have interfaces that would extend in the thickness direction. Likewise an adjacent polymeric segment in the thickness direction would form an interface that extends in the cross direction. Generally orthogonal interfaces have a mean extension that could vary by up to 10 degrees from the orthogonal x and z planes of the film and still be considered orthogonal interfaces. Generally at least 50 (in some embodiments, at least 70 or 90) percent of the polymer segments have orthogonal interfaces.

A polymer segment exposed on a surface of the film could be selected for its surface properties or its bulk properties (e.g., tensile strength, elasticity, color, etc). The “at least two different polymeric compositions” referred to in the method or film described herein have at least one difference. For example, the different polymeric compositions could be made of different polymers or a different mixture of the same polymers or could have different additives (e.g., colorants, plasticizers, or compatibilizer.) Also, additional different polymeric compositions may be used (e.g., at least 3, 4, 5, or more different polymeric compositions). Suitable polymeric materials from which the segmented multicomponent polymeric films of the present disclosure can be made include any conventional thermoplastic resin that can be extruded, for example, polyolefins (e.g., polypropylene and polyethylene), polyvinyl chloride, polystyrenes and polystyrene block copolymers, nylons, polyesters (e.g., polyethylene terephthalate), polyurethanes, and copolymers and blends thereof.

In some embodiments of the method of making a segmented multicomponent polymeric film disclosed herein, the at least two different polymeric compositions comprise an elastomeric polymeric composition and an inelastic polymeric composition, wherein the segmented multicomponent polymeric film comprises elastomeric segments and inelastic segments. In some embodiments at least one separated melt stream comprises an elastomeric polymer, and at least one separated melt stream comprises an inelastic polymer, thus forming a multicomponent polymeric film or film layer comprising both elastomeric and inelastic segments. In some embodiments of the segmented multicomponent polymeric film disclosed herein a portion of the polymeric segments are elastomeric, and a portion of the polymeric segments are inelastic. In some embodiments, elastomeric segments and inelastic segments independently alternate in the cross direction and in the thickness direction of the segmented multicomponent polymeric film.

The term “inelastic” refers to polymers that have little or no recovery from stretching or deformation. Inelastic polymeric compositions can be formed, for example, of semicrystalline or amorphous polymers or blends. Inelastic compositions can be polyolefinic, formed predominantly of polymers such as polyethylene, polypropylene, polybutylene, or polyethylene-polypropylene copolymers. In some embodiments, at least one polymeric composition comprises polypropylene, polyethylene, polypropylene-polyethylene copolymer, or blends thereof.

The term “elastomeric” refers to polymers that exhibit recovery from stretching or deformation. Exemplary elastomeric polymeric compositions which can be used in the segmented multicomponent polymeric films disclosed herein include ABA block copolymers, polyurethane elastomers, polyolefin elastomers (e.g., metallocene polyolefin elastomers), polyamide elastomers, ethylene vinyl acetate elastomers, and polyester elastomers. An ABA block copolymer elastomer generally is one where the A blocks are polystyrenic, and the B blocks are conjugated dienes (e.g., lower alkylene dienes). The A block is generally formed predominantly of substituted (e.g, alkylated) or unsubstituted styrenic moieties (e.g., polystyrene, poly(alphamethylstyrene), or poly(t-butylstyrene)), having an average molecular weight from about 4,000 to 50,000 grams per mole. The B block(s) is generally formed predominantly of conjugated dienes (e.g., isoprene, 1,3-butadiene, or ethylene-butylene monomers), which may be substituted or unsubstituted, and has an average molecular weight from about 5,000 to 500,000 grams per mole. The A and B blocks may be configured, for example, in linear, radial, or star configurations. An ABA block copolymer may contain multiple A and/or B blocks, which blocks may be made from the same or different monomers. A typical block copolymer is a linear ABA block copolymer, where the A blocks may be the same or different, or a block copolymer having more than three blocks, predominantly terminating with A blocks. Multi-block copolymers may contain, for example, a certain proportion of AB diblock copolymer, which tends to form a more tacky elastomeric film segment. Other elastomers can be blended with block copolymer elastomers provided that the elastomeric properties are not adversely affected.

Elastomeric compositions may be selected, for example, for their compatibility or adhesion to inelastic compositions in an adjacent segment in the segmented multicomponent polymeric film disclosed herein. Specific polymer pairs, for example, which have good mutual adhesion properties may be selected. For example, tetrablock styrene/ethylene-propylene/styrene/ethylene-propylene is a thermoplastic elastomer with good adhesion to polyolefins, as described in U.S. Pat. No. 6,669,887 (Hilston et al.). End block reinforcing resins and compatibilizers may also be used within elastomeric film segments.

In any of the aforementioned embodiments, the polymeric segments can be selected to provide specific functional or aesthetic properties in one or both directions of the multicomponent polymeric film such as elasticity, softness, hardness, stiffness, bendability, roughness, colors, textures, or patterns. The segmented multicomponent polymeric film could be used with any known extrusion or film process or product. For example, the segmented multicomponent polymeric film could be embossed, laminated, oriented, cast against a microreplicated surface, foamed, extrusion laminated or otherwise manipulated or treated as is known with extrusion formed film or film layers.

The segmented multicomponent polymeric film may comprise projections on at least a portion of the segments. In some embodiments, the projections (e.g., hooks, stems, or ribs) are provided on an inelastic segment. FIG. 10 shows a perspective view of an embodiment of a segmented multicomponent polymeric film 70 according to the present disclosure in which segment 71 is formed to have projections 72. In the illustrated embodiment, the projections are in the form of hooks, which may be used in a hook-and-loop fastening system, and the segmented multicomponent polymeric film 70 is a hook strip. The term “hook” as used herein relates to a projection with the ability to be mechanically attached to a loop material. Generally, hooks have a stem portion and a loop-engaging head, where the head shape is different from the shape of the stem. For example, to be considered a hook, the projection may be in the shape of a mushroom (e.g., with a circular or oval head enlarged with respect to the stem), a hook, a palm-tree, a nail, a T, or a J. Projections 72 may be formed in any desired segment of the segmented multicomponent polymeric film 70. Hook strips according to and/or made according to the present disclosure could also have both elastomeric and inelastic segments arranged side-by-side and/or in layers. In some embodiments, the polymeric segments provided with projections comprise an inelastic material and are located adjacent to polymeric segments comprising a second material having a lower modulus than the inelastic material. In some embodiments, the second material is an elastomeric material. In some embodiments, segmented multicomponent polymeric film 70 may be formed with elastomeric and inelastic segments and with projections formed along opposite edges of the film, with the center of the film being free of projections. In some of these embodiments, at least some of the elastic segments are located in the center of the film and in the segments with projections.

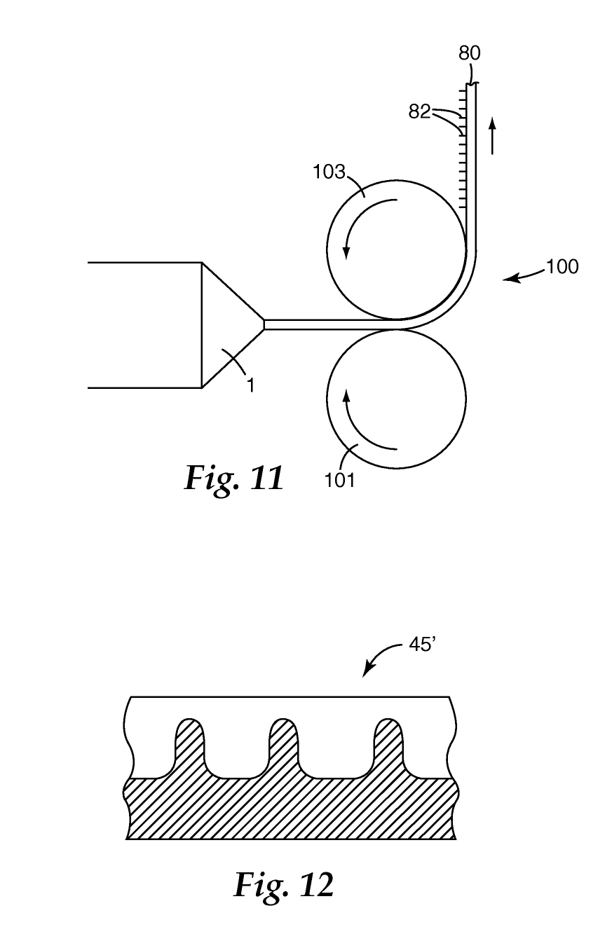

The projections provided on at least some of the polymeric segments can be formed using methods known in the art. For example, the segmented multicomponent polymeric film, upon exiting the die 1, can be fed onto a continuously moving mold surface with cavities having the inverse shape of the projections. The cavities may be the inverse of the shape of functional hook elements or may be the inverse of the shape of a precursor to a hook element (e.g., a partially formed hook element). In some embodiments, the projections (e.g., hooks, stems, or ribs) are formed as schematically shown in FIG. 11. Segmented multicomponent polymeric film 80 after leaving the die 1 is passed between a nip formed by two rolls 101, 103. Alternatively the polymeric film could be nipped, for example, between a die face and roll surface. At least one of the rolls 103 has cavities (not shown) in the inverse form of projections. Pressure provided by the nip forces the resin into the cavities. In some embodiments, a vacuum can be used to evacuate the cavities for easier extrusion into the cavities. The nip is sufficiently wide such that a coherent film backing 80 is also formed over the cavities. The mold surface and cavities can be air or water cooled (e.g., by air or water) before stripping the integrally formed backing and upstanding formed stems from the mold surface such as by a stripper roll. This provides a segmented multicomponent polymer film 80 having integrally formed upstanding stems or hooks 82.

In some embodiments, the projections formed using the process described above have a construction as shown in FIG. 10a. In FIG. 10a, projections 82 are formed on a segment 80 having an upper layer 84 of polymeric material and a lower layer 86 of polymeric material. The lower layer 86 forms the base of the segment and a column of core material for projections 82. The upper layer 84 forms a surface layer on the base and the projections 82. The lower layer 86 of material can form a small portion of the stems, a major portion of the stems, or no part of the stems. By controlling the thickness, viscosity, and processing conditions, numerous different constructions can be made of segments having a base and a stem. These constructions, along with the material selection, can affect the performance of a hook fastener. Typically, for a hook fastener, a least a portion of projections 82 are formed of inelastic material. As an example, upper layer 84 in FIG. 10a may be formed from inelastic material. The backing of the hook fastener can have elastomeric segments. For example, lower layer 86, under the molded projection 82 and forming part of its core, may be formed of elastic material. Or adjacent regions to where the molded projections are provided may be formed of an elastic material. Various configurations of projections made from more than one coextruded material can be found in U.S. Pat. No. 6,106,922 (Cejka et al.), the disclosure of which is incorporated herein by reference in its entirety.

If the projections formed upon exiting the cavities described above in connection with FIG. 11 are not functional hooks, the projections formed could be subsequently formed into hooks by a capping method as described in U.S. Pat. No. 5,077,870, the disclosure of which is incorporated herein by reference in its entirety. Typically, the capping method includes deforming the tip portions of projections 82 using heat and/or pressure. The heat and pressure, if both are used, could be applied sequentially or simultaneously.

Another useful method for providing projections on at least some segments of the segmented multicomponent polymeric film is described, for example, in U.S. Pat. No. 4,894,060 (Nestegard), which discloses a method of preparing profile extruded hooks and is incorporated herein by reference in its entirety. Typically, these projections are formed by passing the web through a patterned die lip (e.g., cut by electron discharge machining) to form a web having downweb ridges, slicing the ridges, and stretching the web to form separated projections. The ribs form a precursor of the male fastening elements and exhibit the cross-sectional shape of the hooks to be formed. The ribs of the thermoplastic web layer are then transversely cut or slit at spaced locations along the extension of the rib to form discrete portions of the rib having lengths in the direction of the rib essentially corresponding to the length of the male fastening elements to be formed.

The method described herein can be used to make a variety of films or filmlike articles as well as other coextruded articles (e.g., privacy film, light film, or coextruded tubing).

### Selected Embodiments of the Disclosure

In a first embodiment, the present disclosure provides a method of making a segmented multicomponent polymeric film, the method comprising:

introducing at least two separated melt streams to a first manipulation stage of an extrusion element comprising at least first and second manipulation stages, wherein the at least two separated melt streams are separated in a first separation dimension and comprise at least two different polymeric compositions;

dividing in a second separation dimension substantially orthogonal to the first separation dimension at least some of the separated melt streams into at least two segmented flow streams;

redirecting at least some of the segmented flow streams, wherein each redirected segmented flow stream is independently redirected in the first separation dimension or the second separation dimension, wherein at least some of the segmented flow streams are sequentially redirected in both separation dimensions in the first and second manipulation stages, respectively; and

converging the segmented flow streams, including the redirected segmented flow streams, and any separated melt streams to form a segmented multicomponent polymeric film having a upper surface and a lower surface, each surface having a different arrangement of the at least two different polymeric compositions in segments that at least partially alternate along the film's cross direction and extend continuously in the film's length direction.

In a second embodiment, the present disclosure provides the method according to the first embodiment, wherein the segmented flow streams are all redirected in the same first or second separation dimension for any given manipulation stage.

In a third embodiment, the present disclosure provides the method according to the first or second embodiment, wherein in the first manipulation stage, at least some of the segmented flow streams are redirected in the second separation dimension, and wherein subsequently in the second manipulation stage at least some of the segmented flow streams are redirected in the first separation dimension.

In a fourth embodiment, the present disclosure provides the method according to the second or third embodiment, wherein there are at least two manipulation stages that redirect the segmented flow streams in the second separation dimension.

In a fifth embodiment, the present disclosure provides the method according to any one of the second to fourth embodiments, wherein there are at least two manipulation stages that redirect the segmented flow streams in the first separation dimension.

In a sixth embodiment, the present disclosure provides the method according to any one of the first to fifth embodiments, wherein dividing and redirecting are both carried out in the first manipulation stage.

In a seventh embodiment, the present disclosure provides the method according to any one of the first to sixth embodiments, wherein the separated melt streams are arranged so as to at least partially alternate the at least two different polymeric compositions in the first separation dimension.

In an eighth embodiment, the present disclosure provides the method according to any one of the first to seventh embodiments, wherein there are at least four separated melt streams introduced to the first manipulation stage, the method further comprising separating in a feedblock at least two feedstock melt streams each into at least two separated melt streams in the first separation dimension to provide the at least four separated melt streams, wherein the at least two feedstock melt streams comprise the at least two different polymeric compositions.

In a ninth embodiment, the present disclosure provides the method according to any one of the first to eighth embodiments, wherein the first and second manipulation stages are formed by at least one die insert.

In a tenth embodiment, the present disclosure provides the method according to the ninth embodiment, wherein each die insert comprises multiple zones along its x-axis, corresponding to the cross direction of the segmented multicomponent polymeric film, and multiple zones along its z-axis, corresponding to a thickness direction of the segmented multicomponent polymeric film, and wherein redirecting at least some of the segmented flow streams comprises redirecting the segmented flow streams into directly adjacent zones of the die insert.

In a eleventh embodiment, the present disclosure provides the method according to the tenth embodiment, wherein the at least two separated melt streams are arranged in alternating zones along the x-axis when they are introduced to the first manipulation stage, and wherein at least some of the separated melt streams are subdivided into the at least two segmented flow streams in directly adjacent zones along the z-axis of the die insert.

In a twelfth embodiment, the present disclosure provides the method according to any one of the first to eleventh embodiments, wherein at least one of the separated melt streams comprises at least two layers of polymer, which layers define a substantially planar interface substantially orthogonal to the first separation dimension.

In a thirteenth embodiment, the present disclosure provides the method according to any one of the first to twelfth embodiments, wherein the at least two different polymeric compositions comprise an elastomeric polymeric composition and an inelastic polymeric composition, and wherein the segmented multicomponent polymeric film comprises elastomeric segments and inelastic segments.

In a fourteenth embodiment, the present disclosure provides the method according to the thirteenth embodiment, wherein the segmented multicomponent polymeric film further comprises projections.

In a fifteenth embodiment, the present disclosure provides the method according to the fourteenth embodiment, wherein the projections are provided on an inelastic segment.

In a sixteenth embodiment, the present disclosure provides a coextruded segmented multicomponent polymeric film having an upper surface and a lower surface, each surface having a different arrangement of polymeric segments that at least partially alternate along the film's cross direction and extend continuously in the film's length direction, wherein at least a portion of the polymeric segments are provided with projections on at least one of the upper surface or the lower surface.

In a seventeenth embodiment, the present disclosure provides the coextruded segmented multicomponent polymeric film according to the sixteenth embodiment, wherein less than 50 percent of the polymeric segments extend to both the upper and lower surfaces of the coextruded segmented multicomponent polymeric film.

In an eighteenth embodiment, the present disclosure provides the coextruded segmented multicomponent polymeric film according to the sixteenth or seventeenth embodiment, wherein at least some of the polymeric segments along the upper surface are adjacent at least three other segments, two on either side in the cross direction along the upper surface and one in the film's thickness direction along the lower surface.

In a nineteenth embodiment, the present disclosure provides the coextruded segmented multicomponent polymeric film according to any one of the sixteenth to eighteenth embodiments, wherein the polymeric segments provided with projections comprise an inelastic polymeric composition and are located adjacent to polymeric segments comprising a second material having a lower modulus than the inelastic polymeric composition.

In a twentieth embodiment, the present disclosure provides the coextruded segmented multicomponent polymeric film according to the nineteenth embodiment, wherein the second material is an elastomeric polymeric composition.

In a twenty-first embodiment, the present disclosure provides a coextrusion apparatus comprising an extrusion element comprising:

a first manipulation stage comprising first flow channels for independently redirecting segmented flow streams in a first separation dimension or a second separation dimension, wherein the first separation dimension is substantially orthogonal to the second separation dimension, wherein the segmented flow streams arise from at least two separated melt streams that are separated in the first separation dimension, with at least some of the separated melt streams further divided in the second separation dimension each into at least two of the segmented flow streams;

a second manipulation stage comprising second flow channels for redirecting at least some of the segmented flow streams in the first separation dimension or the second separation dimension such that at least some of the segmented flow streams are sequentially redirected in both separation dimensions in the first and second manipulation stages, respectively, wherein the second flow channels are in fluid communication with the first flow channels; and

a converging stage comprising third flow channels for converging the segmented flow streams, including the redirected segmented flow streams, and any separated melt streams to form a segmented multicomponent polymeric film, wherein the third flow channels are in fluid communication with the second flow channels.

In a twenty-second embodiment, the present disclosure provides the coextrusion apparatus according to the twenty-first embodiment, further comprising a feedblock comprising fourth flow channels for separating at least two feedstock melt streams each into at least two of the separated melt streams and arranging the separated melt streams so as to at least partially alternate the at least two feedstock melt streams in the first separation dimension, wherein the fourth flow channels are in fluid communication with the first flow channels.

In a twenty-third embodiment, the present disclosure provides the coextrusion apparatus according to the twenty-first or twenty-second embodiment, wherein the first and second manipulation stages are formed by at least one die insert.

In a twenty-fourth embodiment, the present disclosure provides the coextrusion apparatus according to the twenty-third embodiment, wherein each die insert comprises multiple zones along its x-axis, corresponding to the cross direction of the segmented multicomponent polymeric film, and multiple zones along its z-axis, corresponding to a thickness direction of the segmented multicomponent polymeric film, and wherein the first and second flow channels redirect at least some of the segmented flow streams into directly adjacent zones of the die insert.

In a twenty-fifth embodiment, the present disclosure provides the coextrusion apparatus according to the twenty-third or twenty-fourth embodiment, wherein the first manipulation stage comprises a first die insert having multiple zones along its x-axis for receiving the at least two separated melt streams, with at least some of the multiple zones along the x-axis having directly adjacent zones along the z-axis of the first die insert for receiving the at least two segmented flow streams into the first flow channels.

Advantages and embodiments of this disclosure are further illustrated by the following examples, but the particular materials and amounts thereof recited in these examples, as well as other conditions and details, should not be construed to unduly limit the present disclosure. All parts and percentages are by weight unless otherwise indicated.

### EXAMPLES

### Example 1

A coextruded multicomponent segmented polymeric film was made by extruding three polymers. The first polymer, polypropylene, obtained from Dow Chemical Company, Midland, Mich., under the trade designation “C-104” and colored purple using 2% by weight colorant, was fed into a 2.5 inch (6.4 cm) extruder obtained from Davis-Standard, LLC, Pawcatuck, Conn., with an L/D of 24, a screw speed of 4 rotations per minute (rpm), and a rising temperature profile of 400-450° F. (204-232° C.). The material left the extruder at 450 psi (3.1×10⁶ Pa) and was fed into a feedblock 3 (as shown in FIG. 2) through a stainless steel necktube for polymeric composition 10, shown in FIG. 1. The second polymer, “C-104” polypropylene obtained from Dow Chemical Company and colored orange using 2% by weight colorant, was fed into a 1.5 inch (3.8 cm) extruder, obtained from Davis-Standard, LLC, with an L/D of 24, a screw speed of 18 rpm, and a rising temperature profile of 400-450 (204-232° C.). The material left the extruder at 1100 psi (7.6×10⁶ Pa) and was fed into the feedblock 3 through a stainless steel necktube for polymeric composition 11, shown in FIG. 1. The third polymer, “C-104” polypropylene obtained from Dow Chemical Company and colored green using 2% by weight colorant, was fed into 1.25 inch (3.2 cm) extruder, obtained from Davis-Standard, LLC, under the trade designation “KILLION”, with an L/D of 24, a screw speed of 33 rpm, and a rising temperature profile of 425-475° F. (218-246° C.). The material left the extruder at an unknown pressure and was fed into the feedblock through a stainless steel necktube for polymeric composition 12, shown in FIG. 1. Referring now to FIG. 2, the melt then entered feedblock 3 at corresponding locations for melt streams 10′, 11′, 12′. The melt flowed through feedblock 3 and inserts 4, 5, and 6 and then into the die. The inserts were machined to have 6 mm×6 mm flow channels in the configurations shown in FIGS. 4, 5, and 6, respectively. The feedblock was heated to 500° F. (260° C.), and the corresponding coat-hanger die, FIG. 7, which was obtained from Cloeron, Co., Orange, Tex., was 460° F. (238° C.). A flat profile was used for this example. After exiting the die the melt entered a water bath to be quenched. The bath was at a temperature of 60° F. (16° C.). The film having a cross-section as shown in FIG. 9 was then pulled from the water bath on a winder at 11 feet per minute (fpm) (3.4 meters per minute). The film had a thickness of 0.24 mm.

### Example 2

Example 2 was carried out according to the method of Example 1, except that for each of the three polymers, polypropylene obtained from LyondellBasell, Rotterdam, The Netherlands, under the trade designation “7523” was used instead of polypropylene “C-104”. The screw speed for the extruder of the second polymer was 20 rpm, and the screw speed for the extruder of the third polymer was 34 rpm. The film was pulled from the water bath on a winder at 13 fpm.

### Example 3

Example 3 was carried out according to the method of Example 1, except that for the first and third polymers, polypropylene obtained from LyondellBasell under the trade designation “7523” was used instead of polypropylene “C-104”. The screw speed for the extruder of the second polymer was 45 rpm, and the screw speed for the extruder of the third polymer was 34 rpm. The film was pulled from the water bath, which was 66° F. (19° C.) on a winder at 16 fpm.

### Example 4

Example 4 was carried out according to the method of Example 1, except that for the first and third polymers, polypropylene obtained from LyondellBasell under the trade designation “7523” was used instead of polypropylene “C-104”. The screw speed for the extruder of the first polymer was 8 rpm. The screw speed for the extruder of the second polymer was 30 rpm, and the screw speed for the extruder of the third polymer was 63 rpm. A rail profile 45′ was used for this example (shown in FIG. 12). The film was pulled from the water bath, which was 62° F. (17° C.) on a winder at 16 fpm. The film had a base thickness of 0.14 mm, and a rail height of 0.92 mm. The center-to-center spacing between the rails was 1.04 mm, and the rail width measured at half the height of the rail was 0.3 mm.

### Example 5

Example 5 was carried out according to the method of Example 1, except that for the first and third polymers, polypropylene obtained from LyondellBasell under the trade designation “7523” was used instead of polypropylene “C-104”, and for the second polymer an elastomer obtained from Dow Chemical Company under the trade designation “ENGAGE 8200” Polyolefin Elastomer was used instead of polypropylene “C-104”. The screw speed for the extruder of the first polymer was 8 rpm. The screw speed for the extruder of the second polymer was 25 rpm, and the screw speed for the extruder of the third polymer was 63 rpm. A rail profile 45′, which was the same as that used for Example 4, was used for this example. The film was pulled from the water bath, which was 73° F. (23° C.) on a winder at 16 fpm.

Foreseeable modifications and alterations of the present disclosure will be apparent to those skilled in the art without departing from the scope and spirit of the present disclosure. The present disclosure should not be restricted to the embodiments that are set forth in this application for illustrative purposes.

1. A method of making a segmented multicomponent polymeric film, the method comprising:
introducing at least two separated melt streams to a first manipulation stage of an extrusion element comprising at least first and second manipulation stages, wherein the at least two separated melt streams are separated in a first separation dimension and comprise at least two different polymeric compositions;
dividing in a second separation dimension substantially orthogonal to the first separation dimension at least some of the separated melt streams into at least two segmented flow streams;
redirecting at least some of the segmented flow streams, wherein each redirected segmented flow stream is independently redirected in the first separation dimension or the second separation dimension, wherein at least some of the segmented flow streams are sequentially redirected in both separation dimensions in the first and second manipulation stages, respectively; and
converging the segmented flow streams, including the redirected segmented flow streams, and any separated melt streams to form a segmented multicomponent polymeric film having a upper surface and a lower surface, each surface having a different arrangement of the at least two different polymeric compositions in segments that at least partially alternate along the film's cross direction and extend continuously in the film's length direction.

2. The method according to claim 1, wherein the segmented flow streams are all redirected in the same first or second separation dimension for any given manipulation stage.

3. The method according to claim 2, wherein in the first manipulation stage, at least some of the segmented flow streams are redirected in the second separation dimension, and wherein subsequently in the second manipulation stage at least some of the segmented flow streams are redirected in the first separation dimension.

4. The method according to claim 2, wherein there are at least two manipulation stages that redirect the segmented flow streams in the second separation dimension, or wherein there are at least two manipulation stages that redirect the segmented flow streams in the first separation dimension.

5. The method according to claim 1, wherein dividing and redirecting are both carried out in the first manipulation stage.

6. The method according to claim 1, wherein the separated melt streams are arranged so as to at least partially alternate the at least two different polymeric compositions in the first separation dimension.

7. The method according to claim 1, wherein there are at least four separated melt streams introduced to the first manipulation stage, the method further comprising separating in a feedblock at least two feedstock melt streams each into at least two separated melt streams in the first separation dimension to provide the at least four separated melt streams, wherein the at least two feedstock melt streams comprise the at least two different polymeric compositions.

8. The method according to claim 1, wherein at least one of the separated melt streams comprises at least two layers of polymer, which layers define a substantially planar interface substantially orthogonal to the first separation dimension.

9. The method according to claim 1, wherein the at least two different polymeric compositions comprise an elastomeric polymeric composition and an inelastic polymeric composition, and wherein the segmented multicomponent polymeric film comprises elastomeric segments and inelastic segments.

10. The method of claim 9, wherein the segmented multicomponent polymeric film further comprises projections, and wherein the projections are provided on an inelastic segment.

11. A coextrusion apparatus comprising an extrusion element comprising:
a first manipulation stage comprising first flow channels for independently redirecting segmented flow streams in a first separation dimension or a second separation dimension, wherein the first separation dimension is substantially orthogonal to the second separation dimension, wherein the segmented flow streams arise from at least two separated melt streams that are separated in the first separation dimension, with at least some of the separated melt streams further divided in the second separation dimension each into at least two of the segmented flow streams;
a second manipulation stage comprising second flow channels for redirecting at least some of the segmented flow streams in the first separation dimension or the second separation dimension such that at least some of the segmented flow streams are sequentially redirected in both separation dimensions in the first and second manipulation stages, respectively, wherein the second flow channels are in fluid communication with the first flow channels; and
a converging stage comprising third flow channels for converging the segmented flow streams, including the redirected segmented flow streams, and any separated melt streams to form a segmented multicomponent polymeric film, wherein the third flow channels are in fluid communication with the second flow channels.

12. The coextrusion apparatus according to claim 11, further comprising a feedblock comprising fourth flow channels for separating at least two feedstock melt streams each into at least two of the separated melt streams and arranging the separated melt streams so as to at least partially alternate the at least two feedstock melt streams in the first separation dimension, wherein the fourth flow channels are in fluid communication with the first flow channels.

13. The coextrusion apparatus according to claim 11, wherein the first and second manipulation stages are formed by at least one die insert, and wherein each die insert comprises multiple zones along its x-axis, corresponding to the cross direction of the segmented multicomponent polymeric film, and multiple zones along its z-axis, corresponding to a thickness direction of the segmented multicomponent polymeric film, and wherein redirecting at least some of the segmented flow streams comprises redirecting the segmented flow streams into directly adjacent zones of the die insert.

14. The co-extrusion apparatus according to claim 13, wherein the at least two separated melt streams are arranged in alternating zones along the x-axis when they are introduced to the first manipulation stage, and wherein at least some of the separated melt streams are subdivided into the at least two segmented flow streams in directly adjacent zones along the z-axis of the die insert.

15. A coextruded segmented multicomponent polymeric film having an upper surface and a lower surface, each surface having a different arrangement of polymeric segments that at least partially alternate along the film's cross direction and extend continuously in the film's length direction, wherein at least a portion of the polymeric segments are provided with projections on at least one of the upper surface or the lower surface.

16. The coextruded segmented multicomponent polymeric film according to claim 15, wherein less than 50 percent of the polymeric segments extend to both the upper and lower surfaces of the coextruded segmented multicomponent polymeric film.

17. The coextruded segmented multicomponent polymeric film according to claim 15, wherein the polymeric segments provided with projections comprise an inelastic polymeric composition and are located adjacent to polymeric segments comprising a second material having a lower modulus than the inelastic polymeric composition.

18. The coextruded segmented multicomponent polymeric film according to claim 15, wherein at least some of the polymeric segments along the upper surface are adjacent at least three other segments, two on either side in the cross direction along the upper surface and one in the film's thickness direction along the lower surface.

19. The method according to claim 1, wherein the first and second manipulation stages are formed by at least one die insert, and wherein each die insert comprises multiple zones along its x-axis, corresponding to the cross direction of the segmented multicomponent polymeric film, and multiple zones along its z-axis, corresponding to a thickness direction of the segmented multicomponent polymeric film, and wherein redirecting at least some of the segmented flow streams comprises redirecting the segmented flow streams into directly adjacent zones of the die insert.

20. The method according to claim 19, wherein the at least two separated melt streams are arranged in alternating zones along the x-axis when they are introduced to the first manipulation stage, and wherein at least some of the separated melt streams are subdivided into the at least two segmented flow streams in directly adjacent zones along the z-axis of the die insert.
